(19) United States
(12) Patent Application Publication
(10) Pub. No.: US 2005/0044787 A1
(43) Pub. Date: Mar. 3, 2005

(54) Method to extend the life of the rhizome of banana and plantains plant and the use of the rhizome as a conduit to introduce nutrients and systemic inducers to the plant

(76) Inventor: Ambrose Harry Rajamannan, Minneapolis, MN (US)

Correspondence Address: Herman H. Bains, 6101 Tracy Avenue, Minneapolis, MN, 55436, US

(21) Appl. No.: 10/649,205

(22) Filed: Aug. 28, 2003

(51) Int. Cl. A01G 29/00

(52) U.S. Cl. 47/58.1 R

(57) ABSTRACT

A method of extending the life of the rhizome of a banana or plantain plant, for use of the rhizome as a conduit for systemic inducers, comprises allowing growth of suckers on both sides of the mother plant. One of the suckers is selected as a daughter plant which is allowed to mature into a successive mother plant while the other sucker plant is pruned periodically to prevent this other sucker plant from maturing into a producing plant. By maintaining suckers (selected daughter and alternate sucker) on opposite sides of the mother plant in a viable state, the rhizome of the mother plant remains alive. When systemic inducers including nutrients and disease resisting microorganismic substances are introduced into the rhizome of the mother plant, these materials are efficiently distributed into the mother plant, daughter plant and sucker plant.

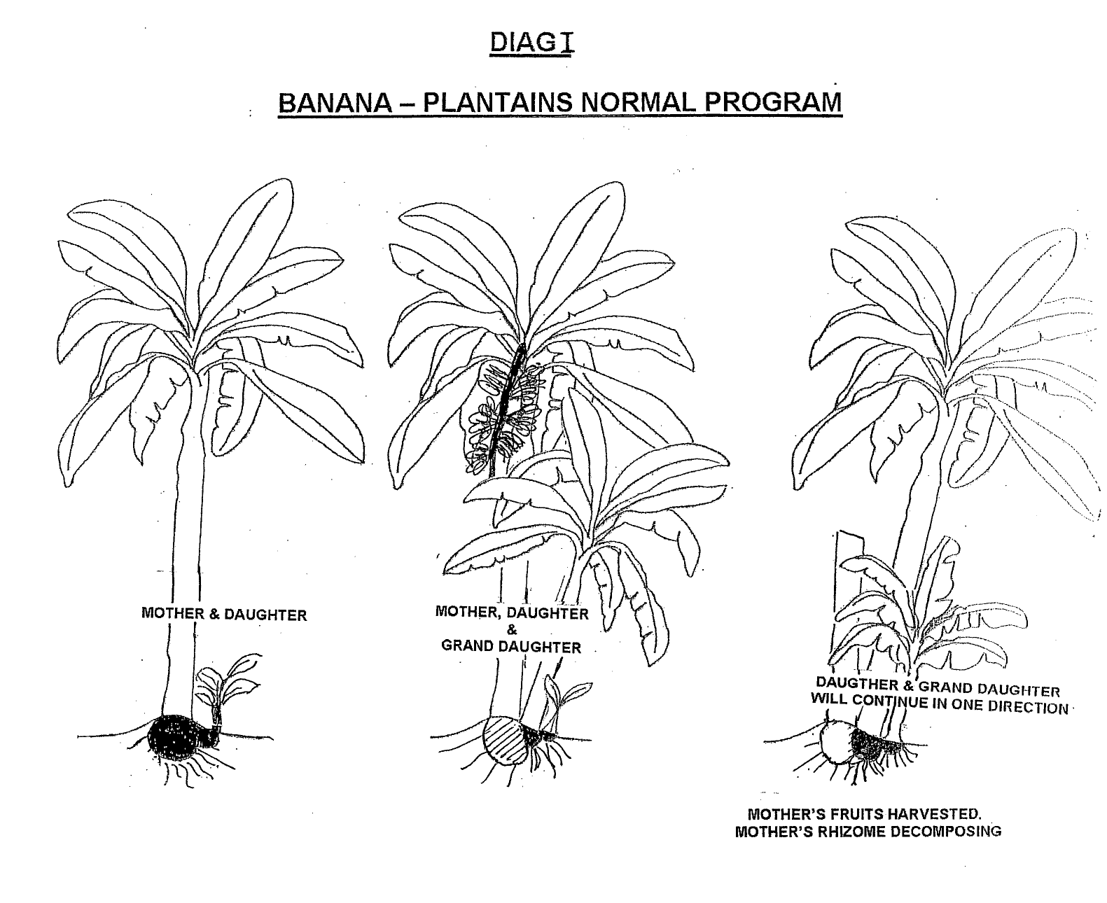

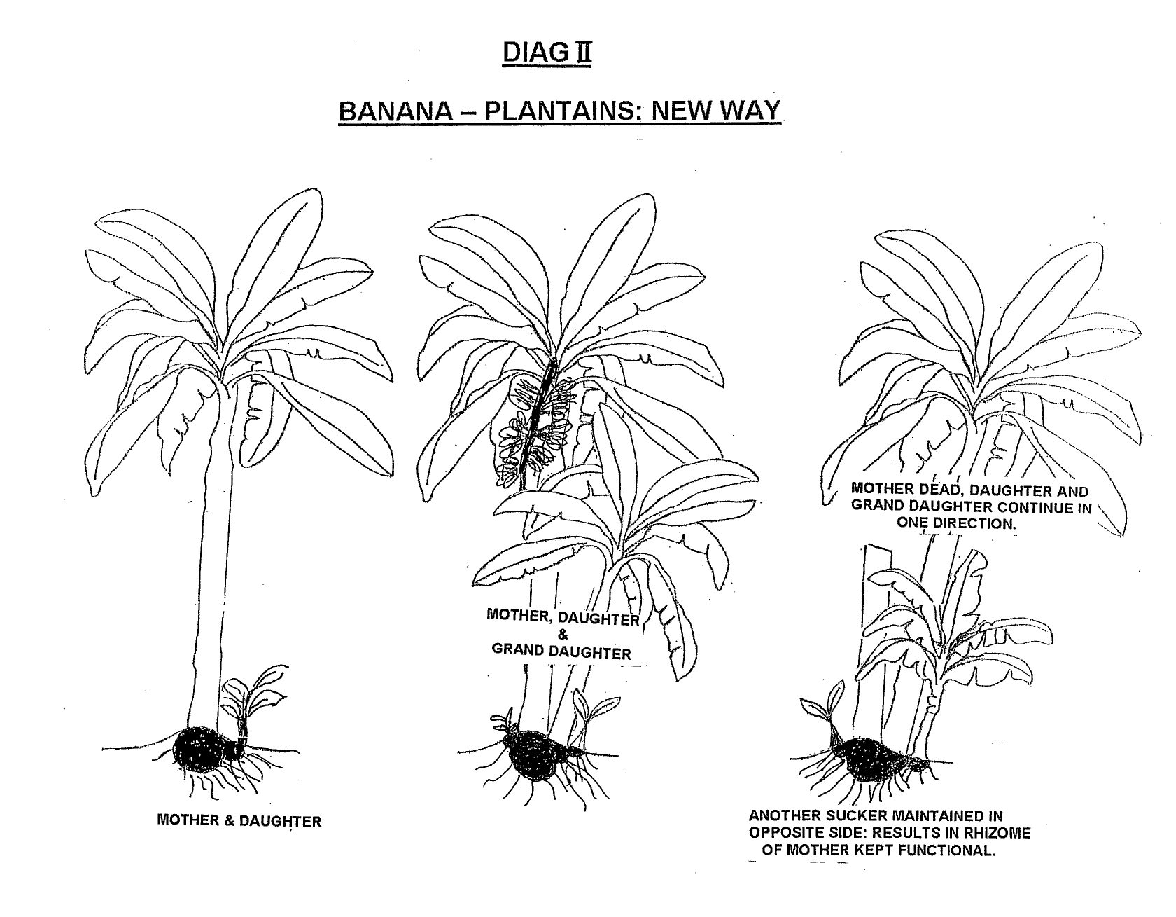

### FIELD OF INVENTION

This invention relates to a method to extend the life of the rhizome of a banana or plantain plant and use of this rhizome as a conduit to transfer nutrients and systemic inducers.

### BACKGROUND OF THE INVENTION

In banana and plantains the true stem is partly or fully underground. This true stem is called a rhizome (corm by some). The stem you see above ground is a false or pseudo stem consisting of the sheath of leaves.

These plants propagate by producing young plants or suckers which grow out of vegetative buds set on the rhizome. These suckers can grow from the rhizome in all directions.

Usually one of these suckers is selected by the grower to grow into the next generation plant. The rhizome however can produce another sucker on the opposite side of the next generation plant selected by the grower. The grower will normally kill these unwanted suckers.

Usually the rhizome of the mother plants will die off after the fruit bunch is 2 to 4 months. The pseudo stem dries off slowly harvested. This process may take up to and dies down to the ground. While the pseudo stem or leaf sheath is green almost all the nutrients stored in this pseudo stem flows down to the rhizome and goes on to feed the growing sucker. The rhizome thus is a store house and will transfer all the nutrients stored in her to the growing suckers. Eventually this mother's rhizome rots away and the selected sucker, which will produce the next bunch of fruits will become the mother. This process will continue from generation to generation (See Diagram I and II).

### SUMMARY OF THE INVENTION

An object of this invention is to provide a process or method for extending the life of the rhizome of a mother banana or plantain plant and utilize this natural phenomenon (rhizome) to store and transfer nutrients, to introduce into this rhizome selected inducers of resistance and nutrients so that it benefits the pseudo stem against fungal, bacterial, viral and insect attacks and increases production of the fruits.

### DESCRIPTION OF THE PREFERRED EMBODIMENT

A crucial requirement of this invention is to keep the rhizome of a mother banana or plantain plant alive in order for the rhizome to function as a channel for distributing nutrient and disease resistant material to the mother and daughter plants.

To keep the mother's rhizome from dying and rotting off, the suckers that are normally killed off on the opposite side of the selected sucker, can be kept alive by allowing the alternate sucker or suckers to grow on the opposite side of the selected producing sucker. However, the alternate sucker or suckers are prevented from producing by pruning the pseudo stem of the alternate sucker on a monthly basis so that the alternate sucker will not produce fruits. This keeps the mother rhizome or corm from rotting away and thus keeps the rhizome alive.

Referring to Diagram I and Diagram II, the normal or conventional method of propagating banana or plantain plants is graphically compared to the method used in the novel process. Diagram 1 shows the normal or conventional sequence in propagating the next generation of banana plants from the mother plant to the daughter plant.

In Diagram 1, the mother plant and selected daughter sucker is depicted at the left side of the diagram. The center representation of Diagram 1 depicts the mother plant reaching maturity and fruiting while the daughter plant is growing. The rhizome of the mother plant is still viable but is beginning to dry off. The representation of the right of Diagram 1 shows the pseudo stem and rhizome of the mother plant dead and dried off while daughter plant and granddaughter plant in a growth state. The rhizome of the daughter and granddaughter plants remain healthy and viable.

Referring to Diagram II, the left representation depicts the mother and daughter plants in a growth state. The daughter plant (as in Diagram I) grows out of a vegetative bud on the rhizome of the mother plant. The center representation depicts the mother plant, daughter plant and granddaughter plant in a growth state.

The center representation also shows a non-selected sucker on the left side of the mother plant. The rhizome of the mother plant remains healthy and viable. The representation at the right of Diagram II shows the daughter and granddaughter plants in a growth state while the mother plant has expired. The non-producing sucker located at the left of the dead mother plant is alive but had been pruned to prevent this plant from maturing and producing fruit. The rhizome of the mother plant remains viable and healthy even though the mother plant is dead.

By maintaining a non-selected sucker plant on the side of the mother plant opposite that of the selected daughter plant, the rhizome of the mother plant remains healthy and provides the conduct and storage structure for receiving and distributing nutrients and disease resisting substances to the daughter and granddaughter plants. The rhizome of a mother plant (even after death of the mother plant) is an extremely efficient conduit for supplying nutrients and disease resisting substances to a mother plant and daughter plant.

The nutrients and disease resisting substances may be introduced into the pseudo stem or leaf sheath to supplement the treatment through the rhizome. The effect of using the rhizome as conduct for nutrients and disease resisting inducer substances is healthy plants with increased fruit production.

A systemic inducer including nutrients and microbial substances are introduced into the rhizome of the mother banana or plantain plants. The systemic inducer may be injected or implanted. Implants may be bullets or spikes.

At shooting time of the mother plant, or any time treatment time, a bullet or spike made with systemic inducers including nutrients, microorganismic substances and growth enzymes is introduced into the starchy parenchyma of the rhizome of the mother. The immediate benefits of this treatment will be to feed the growing fruit of the mother, grow the next generation sucker and induce resistance to the mother and the sucker.

The microbial substance may be living microorganism or, alternatively, the microorganisms may be ground up to form an extract. Injecting microbial extracts either in ground up form or injecting live microorganisms constitutes introducing foreign substance into the plant, so the injection of these products are a source of high stress to the plants. However, when combined with plant nutrients the plant develops an anti-stress process biologically, to release phytoalexins, jasmonic acid and other systemic induction products, that enable this plant to resist fungal, bacterial and insect infections. The microbial or microorganismic substance includes live fungi, bacteria viruses or the extracts thereof.

Plant nutrients can be any accepted fertilizer materials such as phosphorus, potassium, calcium, sodium, magnesium, manganese, zinc, copper and iron. Specifically, the nutrients may include one or more of the following: phosphoric acid, phosphorous acid, phosphite salt, phosphate salt, sodium salt, magnesium salt, manganese salt, zinc salt, copper salt, iron salt, sulfuric acid and hydrochloric acid. The nutrient material is combined with the microbial substance. The bullet or spike can be made up of encapsulated ingredients or mixed with polymers or made in layers with controlled solubilization films such that the ingredients will leak into the parenchyma in a slow and useful fashion. The bullet can also be made without any encapsulation so that the ingredients are absorbed immediately.

The bullet can also be replaced by a liquid material which is encapsulated, emulsified or mixed with ingredients such that the liquid can be injected into the parenchyma of the rhizome and the inducers and nutrients will leak or be released into the plant in a slow and useful fashion. The liquid material also can be unencapsulated so that the plant can use these ingredients immediately.

The frequency of introducing the injectable liquid or shooting the bullet into the rhizome will depend on whether one wishes to introduce these substances once a fortnight to once every 9-12 months. Twelve months is the average cycle of growth and reproduction of one generation banana plant. The frequency of injection depends on the dose, concentration of the materials and the quality of the slow release ingredients is used.

These, inducer products may be inserted into rhizome of the mother banana or plantain plant before and during fruiting and also into the next generation suckers. Alternatively, these inducer products can be introduced into the leaf sheaths or pseudo stems as well to supplement the treatment through the rhizome.

The following examples are exemplary of the efficacy of the novel method.

### EXAMPLE I

To determine the efficacy of this invention a banana farm which had produced bananas for several years was selected. This banana farm had plants in various stages of growth.

Ten (10) banana plants which had just flowered were selected and marked as Group A.

Ten (10) banana plants which had just flowered were selected and marked as Group B.

Ten (10) banana plants which had just flowered were selected and marked as Group C.

Ten (10) banana plants which had just flowered were selected and marked as Group D.

The banana plants of Group A were assigned bullet treatment of inducers including nutrients and microoganismic substances introduced into the parenchyma of the rhizome.

The banana plants of Group B were injected with a liquid inducer including nutrients and microoganismic material into the rhizome.

The banana plants of Group C were injected monthly with a liquid inducer including nutrients and microognismic material into the leaf sheaths or pseudo stems.

The banana plants of Group D were assigned as control with NO TREATMENT.

Inducer product selected for Group A was calcium phosphite and microorganismic material compacted into a bullet with traces of sodium bicarbonate to help disintegrate the bullet inside the parenchyma. This bullet was only introduced once into the parenchyma at flowering and again in 3 months into the parenchyma of the sucker and again at flowering of the sucker.

The inducer product selected for Group B was identical to Group A except that an encapsulated vegetable oil was used to encapsulate and release the ingredients slowly into the parenchyma. This was injected at flowering and into the selected sucker in three (3) months and again at flowering.

The inducer product selected for Group C was calcium phosphite combined with an microorganismic material except 1 cc of this combination was diluted with 4 cc of water and injected into the leaf sheaths or pseudo stems monthly.

Banana plants received a 50% reduction of fungicide to the leaves and no nematocides were applied to any plant in the groups.

Results obtained at shooting and harvesting of the fruits from the selected sucker is noted in Table I.

This experiment showed that the treatments of Group A, B and C were effective over the no treatment Group D.

### EXAMPLE II

To determine efficiency of the nutrient combination with a micro-organsmic material vs. nutrient alone, or microorgansmic material alone the following experiment were conducted.

A banana block with merristems (tissue cultured plants) was selected for the experiment.

Five treatments were designed with three replications of 10 plants per replication.

Treatment A was control with no treatment.

In treatment B, the inducer product was a combination of calcium phosphite and extract from bacteria Bacillus subtilis.

In treatment C, the inducer product was calcium phosphite (nutrient) alone.

In treatment D, the inducer product was potassium phosphite (nutrient) alone.

In treatment E, the inducer was extracts of Bacillus Subtilis (microorganismic substance) alone.

In the treatments, the inducer products were injected into the rhizome of the mother plant at monthly intervals and into the leaf sheath every other month at 5 cc per dose per injection. The daughters of the mother plants were allowed to flower and at time of harvest the yield and disease parameters were evaluated. This process took approximate seven (7) months from the start of the experiment. Results obtained are shown on Table II.

The difference where maximum response in production and disease resistance and nematode resistance was in treatment B where the combination of nutrient and a micro-organismic material was injected.

TABLE 1

| | Leaf Disease at | | | | | | | | |
|---|---|---|---|---|---|---|---|---|---|
| | Harvest | | Production & Quality | | | | | Nematodes Formed in Roots in | |
| | Youngest Leaf | | Average | | | | | 1 Gram of Soil | |
| | With | Functional | Weight of | | #of | Basal | Apical | Rrahdophol- | Helicotylenchus |
| | Symptoms | Leaves | Bunch | | Hands | Finger | Finger | us Similis | Dihystera |
| GROUP A | 4.3 | 8.2 | 32 | kg | 8.2 | 14″ | 8.5″ | 5 | 10 |
| GROUP B | 4.2 | 8.0 | 30 | kg | 8.1 | 13.8″ | 8.4″ | 8 | 26 |
| GROUP C | 4.0 | 7.8 | 29.5 | kg | 8.0 | 13.9″ | 8.3″ | 10 | 66 |
| GROUP D | 3.2 | 6.2 | 26 | kg | 7.0 | 13″ | 8.0″ | 250 | 200 |

TABLE II

| | | Yound Leaves | Total Nematode in Roots |
|---|---|---|---|
| | Production | With Symptoms* | in 1 Gram of Soil** |
| Treatment A | 42 lbs. | 4.6 | 276 |
| Treatment B | 56 lbs. | 7.0 | 80 |
| Treatment C | 44 lbs. | 4.8 | 256 |
| Treatment D | 43 lbs. | 4.7 | 262 |
| Treatment E | 39 lbs. | 3.8 | 282 |

*Higher the number, better the disease management.
**Lower numbers means less infection in roots.

1. A method for prolonging the physiological life of a rhizome of a mother banana or plantain plant after the fruit bunch of the mother plant has been harvested, the mother banana or plantain plant including a rhizome having a selected sucker plant as a daughter plant and an alternate sucker plant growing from the rhizome on opposite sides of the mother plant,
periodically pruning the alternate sucker to prevent the alternate sucker from maturing into an adult plant and producing fruit,
introducing a systemic inducer composition containing nutrients and microorganismic substance into the rhizome of the mother plant to provide nutrients and impart disease and insect resistance to the mother and daughter plants such that the mother plant can initially produce and the daughter plant can later produce a fruit bunch with improved yield and quality.

2. The method as defined in claim 1 and introducing an inducer composition containing nutrients and microorganismic substance into the leaf sheath of the mother plant, daughter plant or non-selected sucker plant as a supplemental conduit for introducing nutrients and microorganismic substance into these plants for producing better fruits.

3. The method as defined in claim 1 wherein the nutrient are conventional fertilizers combined with microorganismic substances.

4. The method as defined in claim 1 wherein the nutrient is selected from the group consisting of phosphoric acid, phosphorous acid, phosphite salt, phosphate salt, calcium salt, sodium salt, magnesium salt, manganese salt, zinc salt, copper salt, iron salt, sulfuric acid and hydrochloric acid.

5. The method as defined in claim 1 wherein the microoganismic substance is selected from the group consisting of fungi, bacteria, viruses and the extracts thereof.

6. The method as defined in claim 1 wherein the systemic inducer composition is contained within a solid spike which is implanted within the parenchymatous material of the rhizome where nutrients are stored and whereby nutrients and microorganismic materials are released from the spike in small quantities over a period of time.

7. The method as defined in claim 1 wherein the systemic inducer composition comprises a liquid which is introduced into the rhizome of the mother plant to enable the nutrients and microoganismic substance to enter the cells of the plants.

8. The method as defined in claim 1 wherein the systemic inducer composition is contained within a solid spike including a nutrient comprising sodium bicarbonate containing a compressed gas for disintegrating the nutrient into easily soluble forms for absorption by the rhizome.

9. The method as defined in claim 1 wherein the systemic inducer composition is contained within a solid spike including a nutrient comprising a solidified fertilizer containing a gas under pressure for disintegrating the nutrient into easily soluble forms for absorption by the rhizome.

10. The method as defined in claim 8 wherein the compressed gas comprises carbon dioxide.

11. The method as defined in claim 8 wherein the compressed gas comprises compressed air.

12. The method as defined in claim 9 wherein the compressed gas is carbon dioxide.

13. The method as defined in claim 9 wherein the compressed gas is compressed air.
